(19) United States
(12) Patent Application Publication
(10) Pub. No.: US 2025/0111068 A1
(43) Pub. Date: Apr. 3, 2025

(54) METHOD FOR DETERMINING AN ACCESS RIGHT OF A USER, REQUESTING COMPUTER DEVICE, AUTHENTICATING COMPUTER DEVICE, AND AUTHENTICATING SYSTEM

(71) Applicant: TRINAMIX GMBH, Ludwigshafen Am Rhein (DE)

(72) Inventors: Jonas GROSSE HOLTHAUS, Bergisch Gladbach (DE); Vera Charlotte KOCKLER, Ludwigshafen am Rhein (DE); Friedrich SCHICK, Munich (DE); Sharat RAVI SHANKAR, Ludwigshafen am Rhein (DE); Christian HESS, Ludwigshafen am Rhein (DE); Christian LENNARTZ, Ludwigshafen am Rhein (DE)

(21) Appl. No.: 18/832,978

(22) PCT Filed: Feb. 15, 2023
(86) PCT No.: PCT/EP23/53785

§ 371 Date: Jul. 25, 2024

(30) Foreign Application Priority Data
Feb. 15, 2022 (EP) 22156837.1

(51) Int. Cl. G06F 21/62; G06F 21/32

(52) U.S. Cl. CPC G06F 21/6209; G06F 21/32; G06F 2221/2141

(57) ABSTRACT

Disclosed herein is a method for determining an access right of a user to a requesting computer device, the method including, by an authenticating computer device:
receiving (S1) a detector signal containing captured biometric information about the user from the requesting computer device,
authenticating (S2) the user based on the detector signal,
determining (S3) an access right information of the user based on the authentication and based on a prestored access right information indicating user rights associated with one or multiple users, the access right information indicating an extent to which the user is allowed to access the requesting computer device, and
transmitting (S4) the access right information of the user to the requesting computer device.

The present disclosure relates to a method for determining an access right of a user to a requesting computer device. The present disclosure further relates to such a requesting computer device, to an authenticating computer device and to an authenticating system.

Computer devices such as laptops or smartphones can sometimes only be accessed if a user enters credentials, such as a password. These can be stored on the computer device, so any login attempt is authorized locally by the computer device. It can be desirable to let several users access a same computer device, for example when an owner of the computer device lends his device to another person. In such a case, the other person wanting to access the computer device may have to be enrolled, which may be burdensome. It is desirable to provide a more flexible manner of determining an access right of a user.

It is therefore an object of the present disclosure to improve the determination of an access right of a user to a requesting computer device.

According to a first aspect, a method for determining an access right of a user to a requesting computer device is provided. The method comprises, by an authenticating computer device:

a) receiving a detector signal containing captured biometric information about the user from the requesting computer device,

b) authenticating the user based on the detector signal, in particular based on the captured biometric information,

c) determining an access right information of the user based on the authentication and based on a prestored access right information indicating user rights associated with one or multiple users, the access right information indicating an extent to which the user is allowed to access the requesting computer device, and

d) transmitting the access right information of the user to the requesting computer device.

According to a second aspect, a requesting computer device is provided. The requesting computer device includes:
a user interface unit for receiving a login request,
a detector unit for capturing a detector signal containing captured biometric information about the user upon receiving a login request by the user interface unit,
a communication unit for transmitting the detector signal to an authenticating computer device for authenticating the user and determining an access right information of the user and for receiving the access right information of the user from the authenticating computer device, and
a user access manager for managing an access to the requesting computer device based on the received user access right information.

According to a third aspect, an authenticating computer device is provided. The authenticating computer device includes:
an input unit for receiving a detector signal containing captured biometric information about the user from the requesting computer device,
a processor unit for authenticating the user based on the detector signal and determining an access right information of the user based on the authentication and based on a prestored access right information indicating user rights associated with one or multiple users, the access right information indicating an extent to which the user is allowed to access the requesting computer device, and
an output unit for transmitting the access right information of the user to the requesting computer device.

The features and embodiments described in the following apply to both the method of the first aspect, the requesting computer device of the second aspect and the authenticating computer device according to the third aspect.

The access to the requesting computer device by the requesting user is allowed or prohibited automatically based on the biometric information of the user, in particular without the requesting user having to enter a password or credentials. The requesting user can thereby access the requesting computer device more rapidly and/or in a more convenient manner. Basing the access to the requesting computer device on biometric information may render the access to the requesting computer device safer because it is more difficult to falsify biometric information than to steal a password (for example by copying it or hacking it) and misusing it.

In embodiments, the captured biometric information is processed in a low-level representation associated to the biometric information. A low-level representation may include a representation of the detector signal and/or the biometric information requiring less resources in terms memory or bandwidth than the raw data representing the biometric information. For example, a feature vector can be considered a low-level representation. A feature vector is an ordered list of numerical properties of obtained biometric information. It may represent input features to a machine learning model that makes a prediction or classifies the biometric data associated with the feature vector.

Moreover, centralizing the user authentication in the authenticating computer device in particular allows reducing the computational resources required in the requesting computer device for the authentication and determination of the access right. A more efficient user authentication can hence be performed from a perspective of the requesting computer devices. Further, centralizing the user authentication allows avoiding storing the authentication information on a single device. This allows avoiding an enrollment process on a requesting computer device when a new user uses it because the owner of a new requesting computer device may login via the cloud authentication without ever enrolling at his new device. This is also advantageous when requesting computer devices are shared, for example when a guest only temporarily uses a requesting computer device of someone else, or when a requesting computer device is shared in a company or a rental service.

The requesting computer device can be a mobile device, a smartphone, a tablet, a laptop, a personal computer (PC), an automated teller machine (ATM), a media player or any similar device. In particular, the requesting computer device includes a display, which may be a screen or a touch screen, and can be used to display visual information. The requesting computer device may allow interactions with a user, for example via the user interface unit, only if the user is allowed to do so. Whether a user may interact with the requesting computer device or not is defined through the access right (defined through an access right information). Examples for interactions between the user and the requesting computer device are: the requesting computer device allows the user to input text or other data into the requesting computer device, to record an image, a video and/or a sound using the requesting computer device, to access applications stored on the computer device, to access information displayed on the display of the requesting computer device or the like. The access right information may determine what type of interactions between the user and the requesting computer device are allowed and/or prohibited.

Herein, the term “person” can be used as a synonym to the term “user”. The requesting user can be the user wanting to access the requesting computer device and/or whose captured biometric information is included in the detector signal.

The authenticating computer device may be a computer device of the same or a different type as the requesting computer device. For example, the authenticating computer device can be a mobile device, a smartphone, a tablet, a laptop, a personal computer (PC), an automated teller machine (ATM), a media player or any similar device. Preferably, the authenticating computer device is a cloud device that is part of a cloud. A cloud device can be understood very broadly, so any computer device which can receive, store, process and send information is generally usable. One authenticating computer device can be coupled to multiple requesting computer devices for performing authentication of the respective users of the requesting computer devices. The requesting computer device can exchange data with the authenticating computer device wirelessly or through a wire-bound communication channel. For example, the requesting computer device and the authenticating computer device can exchange data via the internet, via Bluetooth, or the like. Some or all of the data that is exchanged between the requesting computer device and the authenticating computer device, for example the detector signal, can be encrypted to secure privacy and/or hinder hacking attacks.

The detector signal can be captured by the requesting computer device, in particular using the detector unit. The detector unit can be a camera, for example a front camera, a fingerprint sensor, an iris scanner, a palm scanner, or the like. Using a camera for face recognition can be advantageous because the face contains a high number of features which allow very secure identification of a person. A face is also very difficult to copy in comparison to a fingerprint, which can for example be reproduced from a touched piece of glass. The detection of the detector signal can be triggered by the reception of a login request, for example by a user interface unit, by the requesting computer device. A login request can be an input by a user who intends to use the requesting computer device.

The detector signal can include (captured) biometric information about the user, in particular about the user who intends to use the requesting computer device and would like to obtain access to the requesting computer device. The biometric information can comprise body measurements and/or calculations related to human characteristics. The biometric information can include physiological characteristics, which are related to the shape of the body, and for example include, but are not limited to mouse movement, fingerprint, palm veins, face recognition, DNA, palm print, hand geometry, iris recognition, skin pattern features, retina and/or scent. The biometric information can include behavioral characteristics which related to the pattern of behavior of a person, which for example include but are and not limited to typing rhythm, gait, signature and/or voice. The biometric information can be information characterizing human characteristics of the user. In particular, a text or password entered into the requesting computer device by the user does not form a biometric information.

If the detector unit is a camera, it may be an infrared (IR) camera. Using an IR camera can be advantageous because a red blue green (RBG) camera of the requesting computer device is often already used or blocked by an application having exclusive access to the RBG camera. In smartphones for example, IR cameras are often used for less purposes, and are typically only used by the operating system of the smartphone for authentication. The detector unit may record a flood light image (which can be an image illuminated by a flood light source), so the image is taken from the scene (surrounding the display device) which is either lighted by ambient light or a flood light source. The detector unit may also record an image while the scene is illuminated with patterned light, for example a point cloud. Such an image can contain information like distance or materials, for example skin. Using flood light, patterned light or a combination of both allows analyzing the scene in great detail and false analyses can be avoided.

The detector signal can be unprocessed (as captured by the detector unit) or processed data (for example, a low-resolution representation and/or an extract of the captured data only). The detector signal can be transmitted from the requesting computer device to the authenticating computer device, for example from the communication unit of the requesting computer device to the input unit of the authenticating computer device.

Once the detector signal is received in the authenticating computer device, the processor unit thereof performs authentication of the user using the received detector signal. In particular, the processor unit can be a central processing unit (CPU). The processor unit may perform feature extraction from the captured biometric information. For example, if the detector signal is an image, the processor unit can perform image processing on the image to detect relevant faces or other human body parts thereon. Body parts detection can include the process of detecting and/or locating said body parts within the image.

Authenticating can refer to determining the identity of the user associated with (in particular, described by) the received detector signal, in particular with the associated captured biometric information. In other words, the identity of the user is determined during authentication based on the detector signal. Authentication can be performed by comparing the features extracted from the captured biometric information with stored biometric information (part of the prestored user information), which is prestored, for example in the authenticating computer device, as will be described in further detail below. A result of the authentication may be the identity of the user associated with the received detector signal. The identity may be expressed through an identification number, the name of the user or the like.

Alternatively or additionally, the requesting user may provide an information about his identity, for example his name, signature, or an identification code to the requesting computer device, which may forward it to the authenticating computer device. The authenticating computer device can then simply check whether the captured biometric information complies with the identity input by the requesting user or not. Providing the requesting user's identity can be an additional security check.

Based on the result of the authentication, the processor unit may determine an access right information associated with the user. The access right information indicates the extent to which the user is allowed to access the requesting computer device. This “extent” can correspond to whether the user is allowed at all to access the requesting computer device, and if so, which applications (apps) or functions of the requesting computer device the user may use.

To determine the access right information associated with the requesting user, the processor unit may compare the identity of the user determined in the authentication step with a prestored access right information. The prestored access right information can include a list of one or multiple user identities and the corresponding access right to the requesting computer device. In particular, for each user identity of the prestored access right information, the prestored access right information can indicate whether the user is allowed at all to access the requesting computer device, and if so, which applications (apps) or functions of the requesting computer device the user may use. The prestored corresponding access right can be set as the access right information for the requesting user. Alternatively, the access right information can include or be determined based on the prestored corresponding access right. The resulting access right information can be transmitted (in particular, sent) to the requesting computer device. Preferably, the output unit of the authenticating computer device may send the access right information to the requesting computer device.

According to an embodiment, the method of the first aspect further comprises:

e) capturing a biometric representation of the user by the requesting computer device, wherein the detector signal corresponds to the biometric representation or to a low-level representation of the biometric representation.

This method step e) may be performed prior to method steps a) to d). Method step e) may be performed by the detection unit described above. The biometric representation can be the detector signal. The requesting computer device may capture the biometric representation and generate a low-level representation thereof, which can correspond to the detector signal. The low-level representation can be a feature vector which only contains those features of an image which are relevant for the authentication. Transferring a low-level representation of the captured biometric representation allows to transfer a lower amount of data, which is advantageous if only a slow connection to the authenticating computer device can be used, such as a telecommunication network with weak signals. However, more computational power is required on the requesting computer device and the analysis software needs to be able to process biometric information. If the detector signal is a biometric representation, the requesting computer device can include a processor unit for processing the biometric representation and generating the low-level representation. This processor unit may be located in a secure enclave of the requesting computer device. Such a secure enclave typically has measures to make sure the detector signal really originates from the requesting computer device and for example not from a hacking attack from outside. This increases the security of the system.

Alternatively, a low-level representation of the detection signal can be generated by the authenticating computer device upon reception of the detection signal. This can decrease the computational resources required in the requesting computer device. Further, the same software can be used for all requesting computer devices. The high calculation power of the authenticating computer device can be used.

In embodiments, the low-level representation is obtained by use of a data-driven model, e.g. a classification model, a machine learned model, an artificial neural network, in particular, a convolutional neural network or a vision transformer. One may contemplate of encoder devices for generating the low-level representation.

In embodiments, the step of authenticating comprises: classifying the biometric information using a trained machine learning model. The machine learning model may include an artifcial neural network, in particular a convolutional neural network.

The neural network (NN) may be trained using training data sets mapping ground truth feature vectors associated with user identities and their assigned access rights. The trained NN then receives feature vectors corresponding to the biometric data of a user and outputs an access right information for the user.

According to a further embodiment, the method of the first aspect further comprises:

f) in the requesting computer device, at least partly allowing or prohibiting an access to the requesting computer device based on the access right information received from the authenticating computer device.

The requesting computer device may use the access right information to accordingly provide or prohibit the access of the requesting user to the requesting computer device. For example, the user access manager unit of the requesting computer device is used to manage the access to the requesting computer device. Depending on the access right information, the requesting user can access none, some or all information and/or functionalities of the requesting computer device. By allowing the access to the requesting computer device in accordance with the access right information, the requesting computer device can be protected against unauthorized uses. A security of the requesting computer device can thereby by improved.

According to a further embodiment, the step of authenticating the user based on the detector signal includes, in the authenticating computer device:

g) extracting biometric features from the received captured biometric information;

h) obtaining prestored user information from a database, the prestored user information indicating prestored biometric features associated with one or multiple users;

i) comparing the extracted biometric features with the prestored biometric features; and

j) determining an identity of the user associated with the captured biometric information based on a result of the comparison between the extracted biometric features and the prestored biometric features, or determining that the user associated with the captured biometric information does not correspond to any of the one or multiple users whose prestored biometric features are prestored in the prestored user information.

The method steps g) to j) can be performed by the processor unit of the authenticating computer device. Extracting biometric features from the received captured biometric information can correspond to performing body part recognition on the received detected signal to obtain a position of the body part. Further, characteristics of the body part (such as a size, color, orientation, shape or the like) can be obtained. These characteristics can correspond to the extracted biometric features.

The prestored user information can be stored in a database, which can be located in the authenticating device or in another device of a same cloud. The prestored user information can include a list of biometric features corresponding to one or several potential users. For example, for each potential user provided in the prestored user information, one or several biometric features associated with this user are provided in the prestored user information. The extracted biometric features can form a vector and the prestored biometric features of the prestored user information can form a vector of the same size with corresponding entries.

When comparing the extracted biometric features with the prestored biometric features, corresponding entries of the two vectors can be compared. The comparison allows determining how alike the extracted biometric features and the prestored biometric features are. A comparison criterion may indicate a required similarity between the extracted biometric features and the prestored biometric features to determine that they belong to the same person. For example, the comparison criterion may define that at least 80% of the compared features must be identical, or that all (or nearly all, for example more than 90%) extracted biometric features (if expressed by numbers) must be within a certain range of the corresponding prestored biometric features. If this comparison criterion is satisfied, the processing unit can determine that the requesting user is the user corresponding to the prestored biometric features. An identity of the requesting user can be determined based on an identify of the user corresponding to the prestored biometric features stored in the prestored user information.

If the extracted biometric features do not match any of the stored biometric features, in particular within the comparison criterion, it is determined that the requesting user is unknown to the authentication device. In this case, the processor unit may determine that the requesting user does not correspond to any of the users for which authentication information is stored. This finding may be communicated to the requesting computer device, for example by transmitting an access right information of the requesting user that denies the access to the requesting computer device to this requesting user. In particular, such an unknown user may not be granted any access to the requesting computing device.

According to a further embodiment, the method according to the first aspect further comprises: k) automatically generating the prestored access right information by the requesting computer device and/or by the authenticating computer device based on a user list provided by the requesting computer device, the user list being a list of contacts provided on the requesting computer device.

The entries of the prestored access right information may be generated by a default. For example, every person for which a relation exists, for example retrieved from the phone book list (an example for the list of contacts), has a certain restricted access to the requesting computer device, for example for a smartphone, the phone function, internet browser and e-mail access are granted, but not rights to install or use other apps. The list of contacts may be a phone book list, a list of contacts on social media, a list of contacts with which the proprietor of the requesting computer device exchanges via email, messages, phone, social media, or the like.

By automatically generating the prestored access right information, the access rights to multiple persons can be determined automatically, with little to no effort. This for example allows a proprietor of a requesting device to lend his device to one of his contacts and the contact to access at least some functionalities of the requesting computer device.

According to another embodiments, the method of the first aspect further comprises, by the requesting computer device and/or by the authenticating computer device:

l) accessing to a data exchange information describing a data exchange between the requesting computer device and the contacts provided on the requesting computer device,

m) determining an intensity of a relationship to the contacts based on the data exchange information, and

n) automatically assigning the extent to which each contact is allowed to access the requesting computer device and storing it in the prestored access right information.

A big data approach is conceivable in which all accessible data of the requesting computer device is analyzed for relationships to other persons, like social media, e-mail exchange. Depending on the intensity of relationship, access rights may be automatically assigned to the found persons. The data exchange information can correspond to any data of the requesting computer device indicating relationships to other persons, like social media, chats, e-mail exchange, telephone calls and the like. The determination of the intensity of a relationship to the contacts is performed based on the data exchange information, in particular based on a frequency of the exchange and a content of the exchange. For example, a first contact, who is contacted daily but only for work, may have a more limited access in terms of the prestored access right information than a second contact, who is contacted weekly but is a sibling. The determination of the intensity of a relationship can be performed using a trained machine learning algorithm trained with labelled data exchange information. The trained machine learning algorithm may receive, as an input, data exchange information, and may output the extent to which each contact is allowed to access the requesting computer device. The prestored access right information can be automatically updated in view of the determined intensity of the relationship. This allows automatically assigning access right information to multiple users. The contacts can be potential users of the requesting computer device.

The steps l), m) and n) can be performed regularly (for example, hourly, daily, weekly or the like) and the prestored access right information can thereby be updated.

According to a further embodiment, the extent to which each contact is allowed to access the requesting computer device is defined by a main user of the requesting computer device.

The main user can be the proprietor of the requesting computer device. The main user may be a user that is currently logged into the requesting computer device. The main user may be a person that is register and/or has the option to manage access to the requesting computer device, for example by providing a list of other persons he allows (entire or partial) access or a list of persons he does not want to access.

According to a further embodiment, the method further comprises, by the requesting computer device and/or by the authenticating computer device:

o) determining a liveliness of the user based on the captured biometric information about the user.

Liveliness determination can correspond to determining whether the captured biometric information is that of a real and living human or not. In other words, liveliness detection allows distinguishing real and living human faces from photos, sculptures, drawings, or other representations of a human. Liveliness detection may be performed such that faces on posters, photos on a desk or the like are not accidentally used to provide the access rights. Thereby, a security of the requesting computer device is ensured. Liveliness detection can be performed by detecting the material skin in a face, for example from a pattern light image, or by detecting blood flow or cardiac activity detected by recording several images at a short interval and comparing these.

According to an embodiment, the requesting computer device of the second aspect is configured to execute the steps of the method of the first aspect.

According to an embodiment, the authenticating computer device of the second aspect is configured to execute the steps of the method of the first aspect.

As indicated above, the captured biometric information may include skin patterns. The following explains how such skin patterns features can be determined from the image. A “skin pattern feature” refers to a pattern feature which has been reflected by skin. Skin pattern features can be determined by making use of the fact that skin has a characteristic way of reflecting light: It is both reflected by the surface of the skin and also partially penetrates the skin into the different skin layers and is scattered back therefrom overlying the reflection from the surface. This leads to a characteristic broadening or blurring of the pattern features reflected by skin which is different from most other materials. This characteristic broadening can be detected in various ways. For example, it is possible to apply image filters to the pattern features, for example a luminance filter; a spot shape filter; a squared norm gradient; a standard deviation; a smoothness filter such as a Gaussian filter or median filter; a grey-level-occurrence-based contrast filter; a grey-level-occurrence-based energy filter; a grey-level-occurrence-based homogeneity filter; a grey-level-occurrence-based dissimilarity filter; a Law's energy filter; a threshold area filter. In order to achieve best results, at least two of these filters are used. Further details are described in WO 2020/187719.

The result when applying the filter can be compared to references. The comparison may yield a similarity score, wherein a high similarity score indicates a high degree of similarity to the references and a low similarity score indicates a low degree of similarity to the references. If such similarity score exceeds a certain threshold, the pattern feature may be qualified as skin pattern feature. The threshold can be selected depending on the required certainty that only skin pattern features shall be taken into account, so minimizing the false positive rate. This comes at the cost of identifying too few pattern features are recognized as skin pattern features, i.e. yield a high false negative rate. The threshold is hence usually a compromise between minimizing the false positives rate and keeping the false negative rate at a moderate level. The threshold may be selected to obtain an equal or close to equal false negative rate and false negative rate.

It is possible to analyze each pattern feature separately. This can be achieved by cropping the image showing the body part while it is illuminated with patterned light into several partial images, wherein each partial image contains a pattern feature. It possible that a partial image contains one pattern feature or more than one pattern features. If a partial image contains more than one pattern feature, the determination if a particular pattern feature is a skin pattern feature is based on more than one partial images. This can have the advantage to make use of the correlation between neighboring pattern features.

The determination of skin pattern features can be achieved by using a machine learning algorithm. The machine learning algorithm is usually based on a data-driven model which is parametrized to receive images containing a pattern feature and to output the likelihood if the pattern feature is skin or not. The machine learning algorithm needs to be trained with historic data comprising pattern features and an indicator indicating if the pattern feature has been reflected by skin or not. Particularly useful machine learning algorithms are neural networks, in particular convolutional neural networks (CNN). The kernels of the CNN can contain filters as described above capable of extracting the skin information out the broadening or blurring of the pattern feature.

According to a fourth aspect, a computer-readable data medium, in particular a non-transitory computer-readable data medium, storing a computer program including instructions for executing steps of the method according to the first aspect or any embodiment thereof is provided.

In embodiments, a computer-program or computer-program product comprises a program code for executing the above-described methods and functions by a computerized control device when run on at least one control computer, in particular when run on the authenticating computer device. A computer program product, such as a computer program means, may be embodied as a memory card, USB stick, CD-ROM, DVD or as a file which may be downloaded from a server in a network. For example, such a file may be provided by transferring the file comprising the computer program product from a wireless communication network.

According to a fifth aspect, use of the user access right information obtained by the method according to the method according to the first aspect or any embodiment thereof for access control of a requesting computer device is provided.

In particular, the requesting computer device uses the received access right information to accordingly decide whether an access (or partial access) to the requesting computer device can be granted to the requesting user or not.

According to a sixth aspect, an authenticating system is provided, which includes:
a requesting computer device according to the second aspect; and
an authenticating computer device according to the third aspect.

Features and embodiments described in view of the second and third aspects also hold for the system of the sixth aspect.

In a further aspect, the requesting computer device, in particular the requesting computer device according to the second aspect or an embodiment thereof, is a smartphone or a tablet having a translucent screen as a display unit serving as the user interface unit. In this aspect, the detector unit is for example a front camera. The detector unit can be located on an interior of the requesting computer device, behind the translucent screen. The detector unit can include an illumination source for emitting light through the translucent screen to illuminate the surroundings. The detector unit can further include an optical sensor for receiving light from the surroundings and passing through the translucent screen. The optical sensor may general a sensor signal in a manner dependent on an illumination of a sensor region or light sensitive area of the optical sensor. The sensor signal may be passed onto a requesting processing unit and/or onto the authenticating computer device to reconstruct an image of the surroundings and/or to process the image, in particular along the lines defined above.

Further possible implementations or alternative solutions of the invention also encompass combinations—that are not explicitly mentioned herein—of features described above or below in regard to the embodiments. The person skilled in the art may also add individual or isolated aspects and features to the most basic form of the invention.

Further embodiments, features and advantages of the present invention will become apparent from the subsequent description and dependent claims, taken in conjunction with the accompanying drawings, in which:

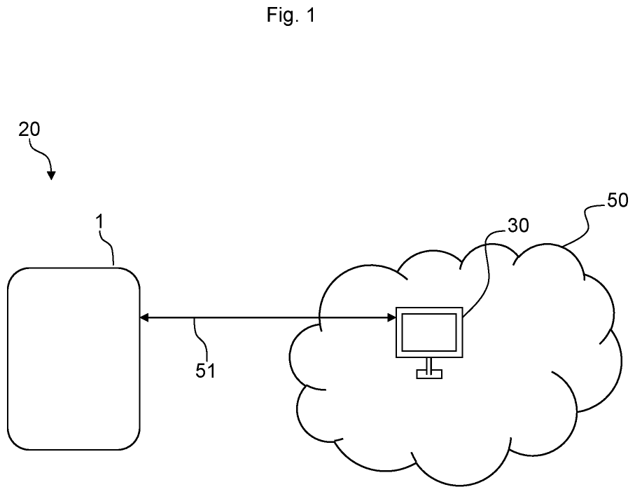

FIG. 1 shows an authenticating system according to an embodiment;

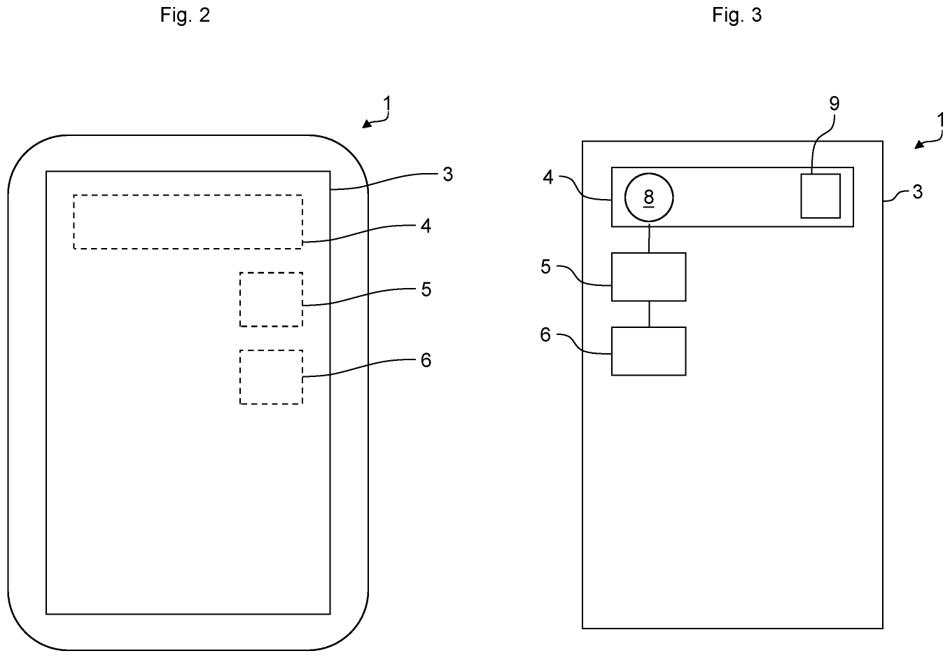

FIG. 2 shows a requesting computer device according to a first embodiment;

FIG. 3 shows components of the requesting computer device of FIG. 1;

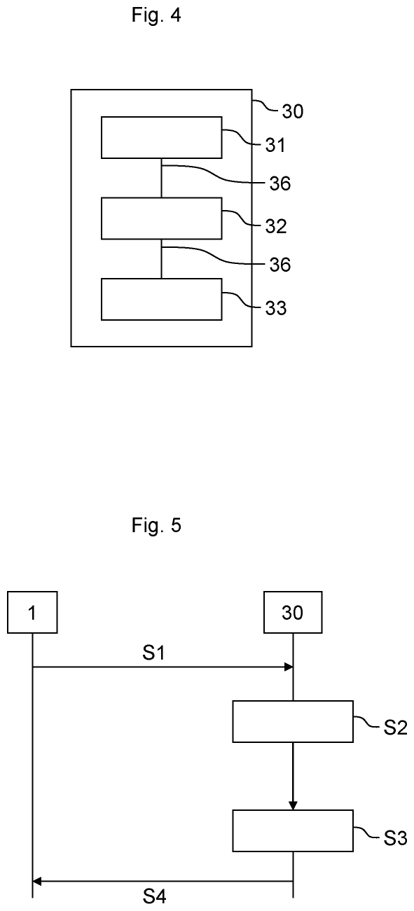

FIG. 4 shows an authenticating computer device according to an embodiment;

FIG. 5 shows a method for determining an access right according to a first embodiment;

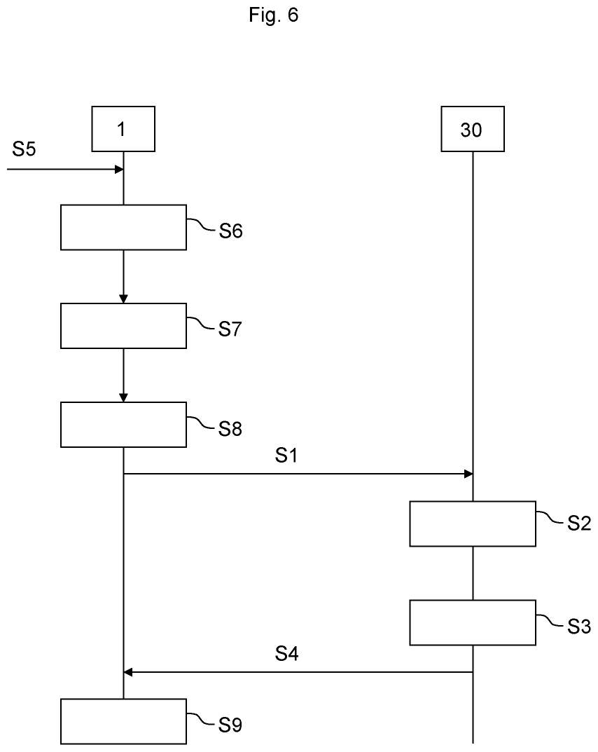

FIG. 6 shows a method for determining an access right according to a second embodiment;

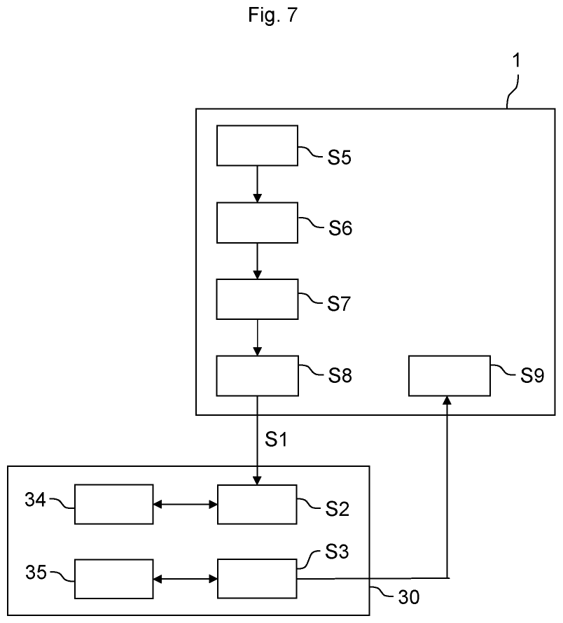

FIG. 7 shows a different representation of the method of FIG. 6;

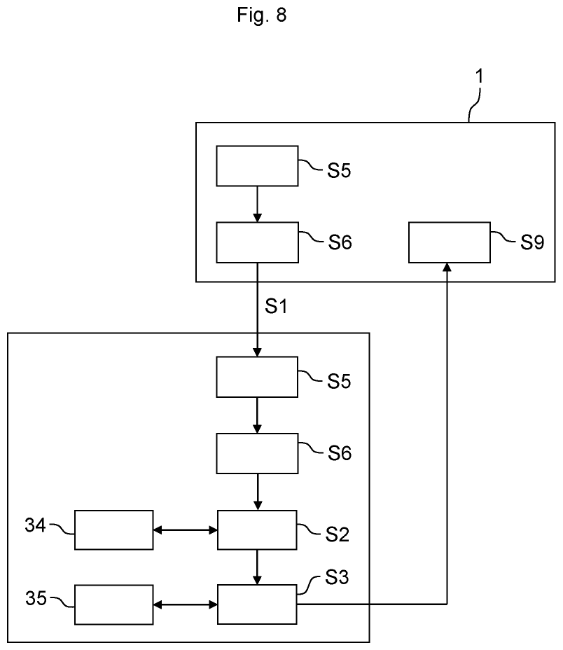

FIG. 8 shows a method for determining an access right according to a third embodiment;

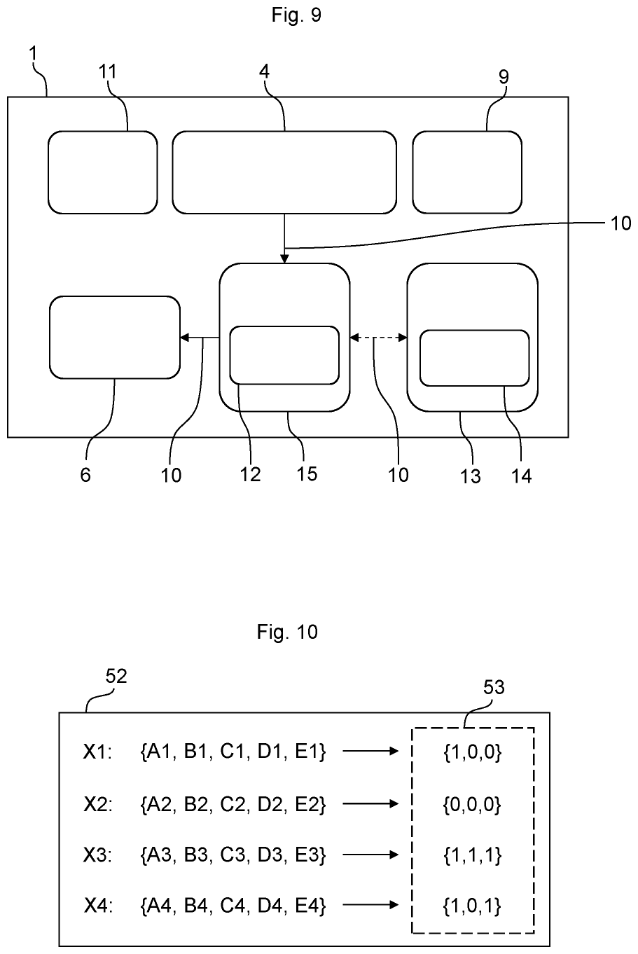

FIG. 9 shows a requesting computer device according to a second embodiment; and

FIG. 10 shows an example for a prestored user information.

In the Figures, like reference numerals designate like or functionally equivalent elements, unless otherwise indicated.

FIG. 1 shows an authenticating system 50 according to an embodiment. The authenticating system 50 includes a requesting computer device 1 realized as a smartphone. Further, the authenticating system 50 includes an authenticating computer device 30 located in a cloud environment 50. The requesting computer device 1 can communicate with the computer device 30 wirelessly via an internet communication channel 51.

FIG. 2 shows a more detailed representation of the requesting computer device 1 of FIG. 1. The requesting computer device 1 (here a smartphone) includes a translucent touchscreen 3 as a display unit, which forms a user interface unit. The display unit 3 is configured for displaying information (such as text, image, diagram, video, or the like) and for receiving information, for example text information, from a user. Besides the display unit 3, the requesting computer device 1 includes a detector unit 4, a communication unit 5 and a user access manager unit 6. In FIG. 2, the detector unit 4, the communication unit 5 and the user access manager unit 6 are represented by dashed squares because they are located within a housing 2 of the requesting computer device 1, and behind the display unit 3 when viewed from an exterior of the requesting computer device 1.

FIG. 3 shows the components of the requesting computer device 1 located on the interior of the housing 2 in more detail. FIG. 3 corresponds to a view onto the display unit 3 from an interior of the requesting computer device 1, with the detector unit 4, the communication unit 5 and the user access manager unit 6 being located in front of the display unit 3.

The detector unit 4 is a front camera in the present example. The detector unit 4 is configured to capture an image of surroundings of the requesting computer device 1. In detail, an image of a scene in front of the display unit 3 of the requesting computer device 1 can be captured using the detector unit 4.

The detector unit 4 includes an illumination source 9 and an optical sensor 7 having a light sensitive area 8. The illumination source 9 is an infrared (IR) laser point projector realized by a vertical-cavity surface-emitting laser (VCSEL). The IR light emitted by the illumination source 9 shines through the translucent display unit 3 and generates multiple laser points on the scene surrounding the requesting computer device 1. When an object, such as a person, is located in front of the requesting computer device 1 (in the surroundings of the requesting computer device 1, facing the display unit 3 and the detector unit 4), an image of the object is reflected towards the detector unit 4. This reflected image also includes reflections of the laser points.

Instead of the illumination source 9 being an IR laser pointer, it may be realized as any illumination source capable of generating at least one illumination light beam for fully or partially illuminating the object in the surroundings. For example, other spectral ranges are feasible. The illumination source may be configured for emitting modulated or non-modulated light. In case a plurality of illumination sources is used, the different illumination sources may have different modulation frequencies. The illumination source may be adapted to generate and/or to project a cloud of points, for example the illumination source may comprise one or more of at least one digital light processing (DLP) projector, at least one Liquid crystal on silicon (LCoS) projector, at least one spatial light modulator, at least one diffractive optical element, at least one array of light emitting diodes, at least one array of laser light sources.

The optical sensor 7 is here realized as a complementary metal-oxide-semiconductor (CMOS) camera. The optical sensor 7 looks through the display unit 3. In other words, it receives the reflection of the object through the display unit 3. The image reflected by the object, such as the person, is captured by the light sensitive area 8. When light from the reflected image reaches the light sensitive area 8, a sensor signal indicating an illumination of the light sensitive area 8 is generated. Preferably, the light sensitive area 8 is divided into a matrix of multiple sensors, which are each sensitive to light and each generate a signal in response to illumination of the sensor.

Instead of a CMOS camera, the optical sensor 7 can be any type of optical sensor designed to generate at least one sensor signal in a manner dependent on an illumination of the sensor region or light sensitive area 8. The optical sensor 7 may be realized as a charge-coupled device (CCD) sensor.

The signals from the light sensitive area 8 form an image, which here corresponds to the detector signal. When the image is an image of a human, the face of the human forms captured biometric information. By analyzing this image, in particular by analyzing a shape of the laser spots reflected by the object and captured by the optical sensor 7, a distance to the object and a material information of the object can be determined. In the example of FIGS. 2 and 3, the detector unit 4, the communication unit 5 and the user access manager unit 6 can exchange data via connection cables 10.

The communication unit 5 is configured to transmit data to the authenticating computer device 30 via the internet communication path 51 shown in FIG. 1. Similarly, the communication unit 5 can receive data from the authenticating computer device 30 via the internet communication path 51.

FIG. 4 shows an authenticating computer device 30 according to an embodiment. The authenticating computer device 30 includes an input unit 31, a processor unit 32 and an output unit 33 linked to one another through communication cables 36.

The functionality of the user interface unit 3, the communication unit 5 and the user access manager unit 6 of the requesting computer device 1 as well as the functionality of the input unit 31, the processor unit 32 and the output unit 33 of the authenticating computer device 30 will be explained in the following in conjunction with the methods shown in FIGS. 5 to 8. In detail, the requesting computer device 1 and/or the authenticating computer device 30 are configured to perform part or the entirety of the methods shown in FIGS. 5 to 8, as will be detailed in the following.

In detail, FIG. 5 shows a method for determining an access right of a user to the requesting computer device 1 according to a first embodiment. In the representation of FIG. 5, the method steps performed by the requesting computer device 1 and the authenticating computer device 30 are shown in parallel, with the steps performed by the requesting computer device 1 being shown along the left vertical line and the steps performed by the authenticating computer device 30 being shown along the right vertical line.

In a step S1, the authenticating computer device 30 receives the detector signal from the requesting computer device 1. In detail, the communication unit 5 of the requesting computer device 1 transmits the detector signal captured by the detector unit 4 to the input unit 31 of the authenticating computer device 30 through the internet communication path 51. The detector signal is here an image of a user requesting an access to the requesting computer device 1 (“requesting user”).

In a step S2, the authenticating computer device 30 authenticates a user based on the received detector signal. This authenticating step is performed by the processor unit 32, which receives the detector signal from the input unit 31. As part of the authentication, the processor unit 32 first extracts biometric features from the received detector signal. Namely, the processor unit 32 performs face detection to detect a face in the received detector signal. The face detection involves identifying whether the received detector signal (here, the received image) includes a face or not, and if a face is included, where it is located. After the face detection, the processor unit 32 extracts biometric features from the identified face. In detail, biometric features such as a shape, color and/or size of the face, eyes, mouth, nose, ears, hair or the like is detected. The face recognition and/or biometric feature extraction may be performed using a trained face detection neural network which is trained using labelled images showing labelled faces, the labels indicating the position and characteristics of features of the face. The trained face detection neural network performs face detection by receiving the detector signal as an input and by outputting an annotated image highlighting the position of the face and a vector with the biometric features extracted from the face. In the present example, the vector includes five biometric feature entries, which are a shape of the face, a shape of the eyes, a color of the eyes, a size of the eyes with respect to the entire face and a shape of the mouth, which can be represented by the vector {A, B, C, D, E}.

Once the vector with biometric features has been extracted from the detector signal, the processor unit 32 compares the extracted biometric features with prestored user information 52 from a database. An example for a prestored user information 52 is shown in FIG. 10. The database is either located in the authenticating computer device 30 or in the cloud environment 50. The prestored user information 52 includes a list of users (defined by an identification number X1-X4) and of their respective biometric features. The prestored user information includes, for each user, a prestored vector with entries corresponding to the entries described above in view of the extracted vector. The prestored vectors are {A1, B1, C1, D1, E1} for user X1, {A2, B2, C2, D2, E2} for user X2, {A3, B3, C3, D3, E3} for user X3 and {A4, B4, C4, D4, E4} for user X4. The processor unit 32 compares the extracted vector with the prestored vectors, in particular by comparing A with A1, A2, A3 and A4, B with B1, B2, B3 and B4, C with C1, C2, C3 and C4 and D with D1, D2, D3 and D4. If the extracted vector is identical with one of the prestored vectors (or similar to a predetermined similarity degree), the processor unit 32 determines that a vector representing the requesting user is provided in the prestored user information and determines an identification number of the user based on the prestored user information. Here, the processor unit 32 determines that A is identical with A3, B is identical with B3, C is identical with C3 and D is identical with D3. The requesting user is hence authenticated as being user X3.

In a step S3, the processor unit 32 determines the access right information associated with user X3. The prestored user information 52 includes a prestored access right information 53 part indicating, for each user X1-X4, user right indicating whether he is allowed to access specific functionalities of the requesting computer device 1. In the example of FIG. 10, the prestored access right information 53 includes, for each user X1-X4, a vector (example for user rights) with three entries, indicating whether the user may respectively access to a camera, an email messaging system and photos of the phone 1. In FIG. 10, the number “1” indicates that an access is granted while the number “0” indicates that the access is prohibited. In step S3, the processor unit 32 reads the entry in the prestored user information 52 associated with user identified in step S2, here for user X3. As indicated by the vector {1, 1, 1}, user X3 is authorized to access all of the above functionalities. The vector {1, 1, 1} is set as the access right information.

The processor unit 32 may implement a trained machine learning model, e.g. a CNN, for classifying the biometric information into access rights.

In a step S4, the authenticating computer device 30 transmits the access right information to the requesting computer device 1. In detail, the output unit 32 sends the access right information to the communication unit 5 via the internet communication path 51.

The requesting computer device 1 can then provide the requesting user with an access to the requesting computer device 1 that corresponds to the received access right information. Since the received access right information is {1, 1, 1}, the requesting computer device 1 allows the requesting user to access all functionalities (access to a camera, an email messaging system and photos) of the requesting computer device 1. Preferably, after the access of the user to the requesting computer device 1, all data relating to this user can be deleted from the storage of the requesting computer device 1. Optionally, this data can be stored in the authenticating computer device 30 or elsewhere in the cloud environment 50.

The method of FIG. 5 can be performed by the authenticating computer device 30 alone. However, the authenticating computer device 30 and the requesting computer device 1 can interact to jointly perform the method of FIG. 6, which shows a method for determining an access right according to a second embodiment. The method of FIG. 6 also includes the method steps S1 to S4, which are identical to those of FIG. 5, and the description of which is hence omitted in the following.

In addition to steps S1 to S4, the method of FIG. 6 includes method steps S5 to S9. In a step S5, the requesting computer device 1 receives a login request. This login request can be received by the user interface unit 3 (display) when a requesting user presses or swipes an unlock button shown on the display 3, thereby indicating that he wishes to access certain functionalities of the requesting computer device 1.

In a step S6 of FIG. 6, triggered by the login request of step S5, the detector unit 4 captures an image (captured biometric representation) of the requesting user, which is here a pattern light image. In a step S7 of FIG. 6, a liveliness of the requesting user is determined based on the captured image. Liveliness determination can correspond to determining whether the captured biometric information is that of a real and living human or not. Liveliness detection is performed by a processor of the requesting computer device 1 which processes the captured image to detect the material skin in a face using the pattern light image.

The process continues with step S7 only if a liveliness is confirmed. In this case, in step S8, the processor of the requesting computer device 1 generates a low-level representation of the captured image and sets it as the detector signal.

After the previously described steps S1 to S4, in FIG. 6, the user access manager unit 6 of the requesting computer device 1 partly allows or prohibits the access to the requesting computer device 1 in accordance with the received access right information. Since the received access right information for user X3 is {1, 1, 1}, the requesting computer device 1 allows the requesting user X3 to access all functionalities (access to a camera, an email messaging system and photos) of the requesting computer device 1. Had one of the values in the access right information been a zero, the user access manager unit 6 would have prohibited the user X3 to access this functionality of the requesting computer device 1.

If no face is detected in the captured image, if the liveliness of the face is not confirmed in step S7 and/or if the requesting user is not known from the prestored user information 52, the method of FIGS. 5 to 8 may stop, a warning message may be displayed on the requesting computer device 1 and/or an access to the requesting computer device 1 by the requesting user may be prohibited.

FIG. 7 shows a different representation of the method of FIG. 6. In the example of FIG. 7, the prestored user information 52 and the prestored access right information 43 are provided in different databases of the authenticating computer device 30. In step S2 of FIG. 7, the processor unit 32 accesses the prestored user information 52 from a template database 34 and in step S3 of FIG. 7, the processor unit 32 accesses the prestored access right information 43 from an access right database 35.

FIG. 8 shows a method for determining an access right according to a third embodiment, which may be performed jointly by the requesting computer device 1 and the authenticating computer device 30. The only difference between the methods of FIGS. 7 and 8 is that in FIG. 8, the step S7 and S8 are performed in the authenticating computer device 30. This allows making use of the usually larger computational power of the authenticating computer device 30.

FIG. 9 shows a requesting computer device 1 according to a second embodiment. The requesting computer device 1 according to the second embodiment is equally configured to perform the method of any one of FIGS. 5 to 8 or parts thereof. However, in addition to the IR laser point projector 9 (patterned light projector) of FIGS. 2 and 3, the display device 1 of FIG. 9 further includes a flood light projector 11 for emitting flood light through the user interface unit 3 toward the surroundings of the display device 1. In FIG. 9, the requesting computer device 1 includes a requesting processor unit 15 for performing image processing for the purpose of liveliness detection and/or generating a low-level representation, as defined in FIGS. 6 and 7.

In FIG. 9, the requesting processor unit 15 uses a trained face detection neural network 12 to recognize the face and its skin characteristics and a trained liveliness detection neural network 14 for liveliness detection based on the performed face detection. Since the information relating to the liveliness detection is security relevant, it is provided on a secure enclave 13 including the neural network 14 used for liveliness detection in step S7.

Although the present invention has been described in accordance with preferred embodiments, it is obvious for the person skilled in the art that modifications are possible in all embodiments. For example, the prestored user information 52 and the prestored access right information 53 may be stored in different files and/or different databases, unlike in FIG. 10. Further, the content of the prestored user information 52 and the prestored access right information 53 can be generated by a main user of the requesting computer device 1, by a defining instance such as a company and/or automatically based on detected interactions between the requesting computer device 1 and a list of contacts provided therein. Further, the order of the described method steps can be modified.

### REFERENCE SIGNS

1 requesting computer device
2 housing
3 user interface unit
4 detector unit
5 communication unit
6 user access manager unit
7 optical sensor
8 light sensitive area
9 illumination source
10 connection cable
11 flood light projector
12 neural network
13 secure enclave
14 neural network
15 requesting processor unit
20 authenticating system
30 authenticating computer device
31 input unit
32 processor unit
33 output unit
34 template database
35 access right database
36 communication cable
50 cloud environment
51 internet communication
52 prestored user information
53 prestored access right information
S1 receiving a detector signal
S2 authenticating user
S3 determining access right information
S4 transmitting access right information
S5 receiving login request
S6 capturing biometric representation
S7 determining a liveliness
S8 generating low-level representation
S9 partly allowing or prohibiting an access

1. A method for determining an access right of a user to a requesting computer device, the method comprising, by an authenticating computer device:
receiving (S1) a detector signal containing captured biometric information about the user from the requesting computer device,
authenticating (S2) the user based on the detector signal,
determining (S3) an access right information of the user based on the authentication and based on a prestored access right information indicating user rights associated with one or multiple users, the access right information indicating an extent to which the user is allowed to access the requesting computer device, and
transmitting (S4) the access right information of the user to the requesting computer device.

2. The method of claim 1, further comprising:
capturing (S6) a biometric representation of the user by the requesting computer device, wherein the detector signal corresponds to the biometric representation or to a low-level representation of the biometric representation.

3. The method of claim 1, further comprising generating at least one feature vector as a low-level representation of the biometric information using a trained machine learning model.

4. The method of claim 1, further comprising:
in the requesting computer device, at least partly allowing or prohibiting (S9) an access to the requesting computer device based on the access right information received from the authenticating computer device.

5. The method of claim 1, wherein the step of authenticating (S2) the user based on the detector signal includes, in the authenticating computer device:
extracting biometric features from the received captured biometric information:
obtaining prestored user information from a database, the prestored user information indicating prestored biometric features associated with one or multiple users: comparing the extracted biometric features with the prestored biometric features; and determining an identity of the user associated with the captured biometric information based on a result of the comparison between the extracted biometric features and the prestored biometric features, or determining that the user associated with the captured biometric information does not correspond to any of the one or multiple users whose prestored biometric features are prestored in the prestored user information.

6. The method according to claim 1, further comprising:
automatically generating the prestored access right information by the requesting computer device and/or by the authenticating computer device based on a user list provided by the requesting computer device, the user list being a list of contacts provided on the requesting computer device.

7. The method of claim 6, further comprising, by the requesting computer device and/or by the authenticating computer device:
accessing to a data exchange information describing a data exchange between the requesting computer device and the contacts provided on the requesting computer device,
determining an intensity of a relationship to the contacts based on the data exchange in-formation, and
automatically assigning the extent to which each contact is allowed to access the requesting computer device and storing it in the prestored access right information.

8. The method of claim 1, wherein the extent to which each contact is allowed to access the requesting computer device is defined by a main user of the requesting computer device.

9. The method of claim 1, further comprising, by the requesting computer device and/or by the authenticating computer device:
determining (S7) a liveliness of the user based on the captured biometric information about the user.

10. A computer-readable data medium storing a computer program including instructions for executing steps of the method according to claim 1.

11. A method of using of the user access right information obtained by the method according to claim 1, the method comprising using the user access right information for access control of a requesting computer device.

12. A requesting computer device, including
a user interface unit for receiving a login request,
a detector unit for capturing a detector signal containing captured biometric information about the user upon receiving a login request by the user interface unit,
a communication unit for transmitting the detector signal to an authenticating computer device for authenticating the user and determining an access right information of the user and for receiving the access right information of the user from the authenticating computer device, and
a user access manager unit for managing an access to the requesting computer device based on the received user access right information.

13. A requesting computer device according to claim 12, which is configured to execute the steps of claim 2.

14. An authenticating computer device for determining an access right of a user to a requesting computer device, comprising
an input unit for receiving a detector signal containing captured biometric information about the user from the requesting computer device,
a processor unit for authenticating the user based on the detector signal and determining an access right information of the user based on the authentication and based on a prestored access right information indicating user rights associated with one or multiple users, the access right information indicating an extent to which the user is allowed to access the requesting computer device, and
an output unit for transmitting the access right information of the user to the requesting computer device.

15. An authenticating computer device, which is configured to execute the steps of claim 5.

16. An authenticating system including:
a requesting computer device; and
the authenticating computer device according to claim 14.

17. A requesting computer device, which is configured to execute the steps of claim 3.

18. A requesting computer device, which is configured to execute the steps of claim 6.

19. A requesting computer device, which is configured to execute the steps of claim 7.

20. A requesting computer device, which is configured to execute the steps of claim 9.
